(19) United States
(12) Patent Application Publication
(10) Pub. No.: US 2009/0234740 A1
(43) Pub. Date: Sep. 17, 2009

(54) ADVERTISEMENT DISPLAY SYSTEM

(76) Inventor: Shahrooz Jabbari, San Jose, CA (US)

Correspondence Address: JAY M. SCHLOFF;INTELLIPEX PLLC, 30200 TELEGRAPH RD, SUITE 245, BINGHAM FARMS, MI, 48025, US

(21) Appl. No.: 12/404,669

(22) Filed: Mar. 16, 2009

Related U.S. Application Data
(60) Provisional application No. 61/037,008, filed on Mar. 17, 2008.

(51) Int. Cl. G06Q 30/00; G09G 3/30; G09G 3/36

(52) U.S. Cl. 705/14; 345/76; 345/87

(57) ABSTRACT

Disclosed is an advertisement display system for displaying advertisements on a vehicle. The advertisement display system includes a display module and an array of solar panels. The display module is capable of being mounted on the vehicle and is configured to receive and display advertisement content. The array of solar panels is capable of being mounted on the vehicle and is configured to provide power to the display module for displaying the advertisement content.

### CROSS-REFERENCE TO RELATED APPLICATIONS

The present invention claims priority under 35 United States Code, Section 119 on the U.S. Provisional Patent Application numbered 61/037,008 filed on Mar. 17, 2008, the disclosure of which is incorporated by reference.

### FIELD OF THE INVENTION

The present invention relates in general to display of advertisements, and more particularly, to an advertisement display system configured on a vehicle for displaying advertisements.

### BACKGROUND OF THE INVENTION

An advertisement typically serves as means for disseminating information regarding a product or a service to consuming population. Merchants and business establishments utilize advertisements for promoting business and for distinguishing products and services from competing products and services in market. The advertisement of products and services may be performed using print media, such as by newspapers, magazines, signboards and hoardings, and/or using electronic media, such as radio, television and internet.

With the advancement in content display techniques, advertisements are now displayed on every conceivable location for information dissemination purposes. Accordingly, advertisements are now displayed on building rooftops, scaffoldings, and even on vehicles, such as buses, taxis, subways, and trains. The use of the vehicles for displaying the advertisements provides an efficient way of promoting the products and the services to a majority of audiences on a repeated and consistent basis. Further, displaying advertisements on vehicles enables the merchants and the business establishments to promote the products and the services in a cost effective manner.

Typically, stickers including advertisement content related to the products and the services are pasted on bodies of the vehicles for displaying the advertisements. For example, weatherproof stickers including the advertisement content are typically placed on either side of buses. However, such stickers lack in providing flexibility in advertising the products and the services, as such advertisements are “static” i.e., the stickers are permanently or semi-permanently affixed to the side of the buses. Further, in order to change messages or captions on the stickers, it is necessary to manually change the messages or the captions on the stickers either by replacing the stickers or repainting/repapering the stickers. Furthermore, the advertisements on vehicles do not possess any inherent environmental benefits and do not generate environmental awareness amongst people viewing these advertisements.

Accordingly, there exists a need for precluding manual changing of stickers for changing advertisements displayed on vehicles. There also exists a need for precluding static display of advertisements displayed on vehicles. Further, there exists a need for displaying advertisements on vehicles in an environmentally friendly and in a cost effective manner.

### SUMMARY OF THE INVENTION

In view of the forgoing disadvantages inherent in the prior-art, the general purpose of the present invention is to provide an advertisement display system that is configured to include all advantages of the prior art, and to overcome the drawbacks inherent in the prior art.

An object of the present invention is to preclude manual changing of stickers pasted on bodies of vehicles for changing advertisements displayed on the vehicles.

Another object of the present invention is to preclude static display of advertisements displayed on vehicles.

Yet another object of the present invention is to display advertisements on vehicles in an environmentally friendly and in a cost effective manner.

To achieve the above objects, in an aspect of the present invention, an advertisement display system is provided. The advertisement display system includes a display module and an array of solar panels. The display module is capable of being mounted on a vehicle and is configured to receive and display advertisement content. The array of solar panels is capable of being mounted on the vehicle and is configured to provide power to the display module for displaying the advertisement content.

The display module is configured to display advertisements in a dynamic manner. In an embodiment of the present invention, the display module includes at least one display screen. Each display screen of the at least one display screen is capable of displaying at least one of a dynamic advertisement content and a static advertisement content. The display module precludes the need to paste stickers on the bodies of the vehicles and as such manual changing of the stickers for displaying advertisements is precluded. Further, the advertisement display system may be configured with an electrical interface for receiving advertisement content, and, a storage module for storing the received advertisement content. The received advertisement content may then be displayed in a dynamic manner thereby precluding static display of advertisements displayed on vehicles.

Further, each display screen of the at least one display screen may be an Organic Light Emitting Diode (OLED) screen. Furthermore, the utilization of an array of solar panels and a rechargeable lithium ion battery for generating power precludes a need to use disposable batteries for powering the display module. The use of OLED screen, the array of solar panels and the rechargeable lithium ion batteries possesses inherent environmental benefits and may generate environmental awareness amongst people viewing the advertisement content. The display module may also be configured to display advertisement content related to environmental issues and thereby enable generating awareness regarding the environmental issues. Further, the dynamic display of advertisements enables merchants and business establishments to preclude printing costs, such as for printing advertisement content, thereby enabling display of advertisements in a cost effective manner.

This together with the other aspects of the present invention, along with the various features of novelty that characterized the present invention, is pointed out with particularity in the claims annexed hereto and forms a part of the present invention. For a better understanding of the present invention, its operating advantages, and the specified object attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing, wherein like elements are identified with like symbols, and in which:

FIG. 1 illustrates an schematic block diagram of an advertisement display system for displaying advertisements on a vehicle, in accordance with an embodiment of the present invention;

FIG. 2 illustrates an advertisement display system mounted on a bus for displaying advertisements, in accordance with an exemplary embodiment of the present invention; and

FIG. 3 illustrates an advertisement display system including a display module configured with multiple display screens for displaying advertisements on a bus, in accordance with another exemplary embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to an advertisement content display system, as shown and described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

The terms “a” and “an” herein do not denote a limitation of quantity, but rather denote the presence of at least one of the referenced item.

The present invention provides an advertisement display system. The advertisement display system is capable of being mounted on a vehicle for displaying advertisement content. The advertisement display system is capable of displaying at least one of dynamic advertisement content and static advertisement content. Further, the advertisement display system is capable of displaying the advertisement content in an environmentally friendly and a cost effective manner.

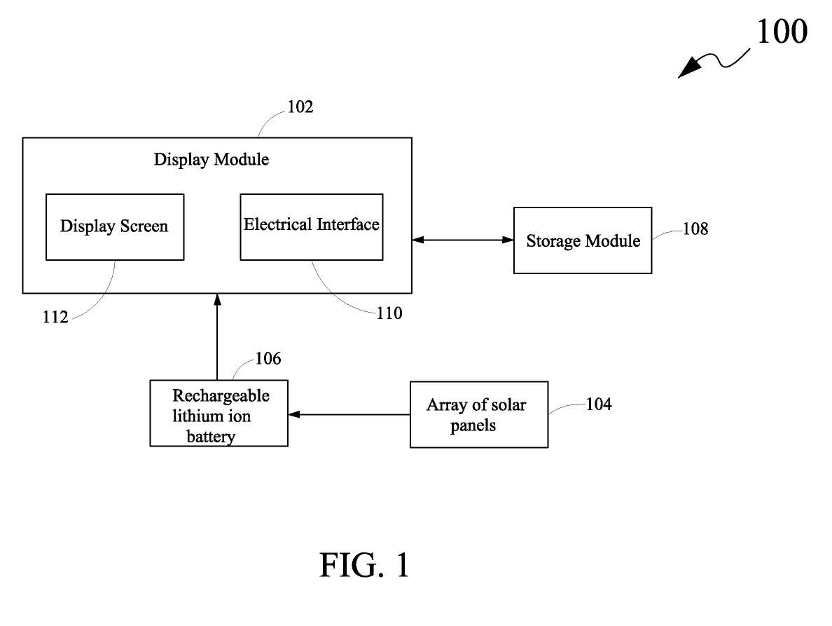

Referring now to FIG. 1, a schematic block diagram of an advertisement display system 100 (hereinafter referred to as “a system 100”) is illustrated, in accordance with an exemplary embodiment of the present invention. The system 100 includes a display module 102, an array of solar panels 104, a rechargeable lithium ion battery 106, and a storage module 108. The display module 102 includes an electrical interface 110 and a display screen 112. The display module 102 is capable of receiving and displaying advertisement content. The array of solar panels 104 is capable of providing power to the display module 102 for displaying the advertisement content. Specifically, the rechargeable lithium ion battery 106 is capable of being recharged by the array of solar panels 104 for providing power to the display module 102. In another embodiment, the lithium ion battery 106 may be operatively coupled to power supply of a vehicle to which the system 100 is attached such that the vehicle may charge the battery 106.

The storage module 108 is capable of storing the received advertisement content. The storage module 108 is electrically coupled to the display module 102 for enabling the display module 102 to display the stored advertisement content of the storage module 108. Specifically, in an embodiment of the present invention, the storage module 108 may be a memory unit, such as a flash memory, a cache memory, a Random Access Memory (RAM) or a Read Only Memory (ROM), capable of storing the advertisement content to be displayed by the display module 102.

As explained herein the display module 102 is capable of receiving the advertisement content. Specifically, in the present embodiment, the display module 102 is configured with the electrical interface 110 for receiving the advertisement content.

In one embodiment of the present invention, the electrical interface 110 is at least one of a Universal Serial Bus (USB) interface, a wireless communication port, an infrared port, a compact disc (CD) reader, and a Digital Video Device (DVD) reader, which enables the display module 102 to receive the advertisement content. Further, the advertisement content received from the electrical interface 110 may be stored in the storage module 108. In embodiment, the wireless communication port may include a Bluetooth or a WiFi receiver. It will further be apparent that an external CD reader or DVD reader may be operatively coupled with the display module 102 by way of the USB interface, wireless communication port, or infrared port.

Moreover, as explained herein, the display module 102 is capable of displaying the advertisement content. Specifically, the display module 102 includes at least one display screen, such as the display screen 112, capable of displaying the advertisement content. In a preferred embodiment of the present invention, each display screen, such as the display screen 112, of the at least one display screen of the system 100 is an organic light emitting diode (OLED) screen. The use of the OLED screen enables in reducing power consumption for displaying the advertisement content thereon. In another embodiment of the present invention the each display screen, such as the display screen 112, of the at least one display screen may be a plasma screen or a liquid crystal display (LCD) screen, capable of displaying the advertisement content.

Further, it will be evident to those skilled in the art that components of the system 100 such as the display module 102 and the storage module 108 may be implemented as a hardware module, a software module, a firmware module, or any combination thereof. Furthermore, it will be obvious to those skilled in the art that the system 100 may include requisite electrical connections for communicably coupling the various components of the system 100 such as the display module 102, the array of solar panels 104, the rechargeable lithium ion battery 106, and the storage module 108. It will likewise be apparent that the wireless communication port of the electrical interface 110 may reduce the wiring or physical coupling of the various components of the system 100.

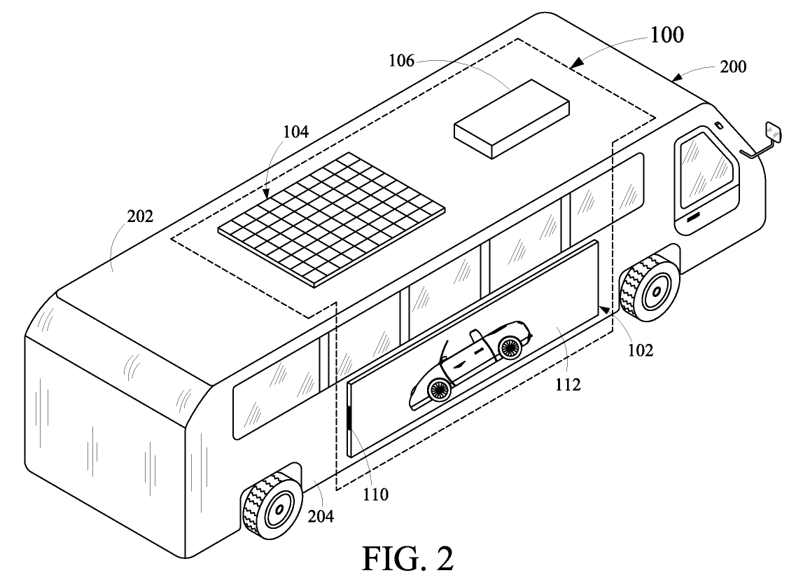

The system 100 of the present invention is capable of being configured on a vehicle to display the advertisement content, which is explained in detail in conjunction with FIG. 2.

Referring now to FIG. 2, the system 100 (outlined by dotted lines) mounted on a bus 200 for displaying advertisement content is illustrated, in accordance with an exemplary embodiment of the present invention. It will be evident to person skilled in the art that the system 100 mounted on the bus 200 is depicted for exemplary purposes and that the system 100 may be mounted on any vehicle, such as a car, a subway, a train and the like, for displaying the advertisement content.

As shown in FIG. 2, the display module 102 and the array of solar panels 104 are mounted on the vehicle, such as the bus 200. Specifically, in present embodiment, the array of solar panels 104 is mounted on a rooftop 202 of the bus 200 and the display module 102 is mounted on a side wall portion 204 of the bus 200. In an exemplary embodiment of the present invention, the side wall portion 204 and the rooftop 202 of the bus 200 may be configured with slots adapted to receive the display module 102 and the array of solar panels 104, respectively, therein. Thereafter, a suitable fastening mechanism, such as a clamp and screw arrangement (not shown), may be used for mounting the display module 102 and the array of solar panels 104 on the side wall portion 204 and the rooftop 202 of the vehicle, respectively.

The rechargeable lithium ion battery 106 is also mounted on the rooftop 202 of the bus 200. The rechargeable lithium ion battery 106 may be mounted on the rooftop 202 in a manner similar to the mounting of the array of solar panels 104 on the rooftop 202. Further, as explained herein, the solar panels 104 and the rechargeable lithium ion battery 106 of the system 100 is capable of providing power to the display module 102. In an embodiment of the present invention, the system 100 further includes at least one alternative power source for providing power to the display module 102. More specifically, the at least one alternative power source is a rechargeable battery (not shown) of the vehicle, such as the bus 200, which is capable of providing power to the display module 102 for displaying the advertisement content. For example, once the charge of the rechargeable lithium ion battery 106 is drained, the display module 102 may acquire power from the rechargeable battery of the vehicle for displaying the advertisement content. In another embodiment, the rechargeable lithium ion battery 106 may be operatively coupled to the electrical or power supply of the bus 200 such that the battery may be recharged thereby.

In one embodiment of the present invention, the system 100 may operate on Alternating current (AC) power supply. For example, the power provided by the rechargeable lithium ion battery 106 and the rechargeable battery of the vehicle to the display module 102 is the AC power supply. Specifically, the system 100 includes capacitors (not shown) and direct current (DC) inverters (not shown) electrically coupled to the rechargeable lithium ion battery 106 and the rechargeable battery of the vehicle. The capacitors and the DC inverters enable in converting the power provided by the rechargeable lithium ion battery 106 and the rechargeable battery of the vehicle to the AC power supply. However, it will be apparent to person skilled in the art that the system 100 may operate on DC power supply provided by the rechargeable lithium ion battery 106 and the rechargeable battery of the vehicle.

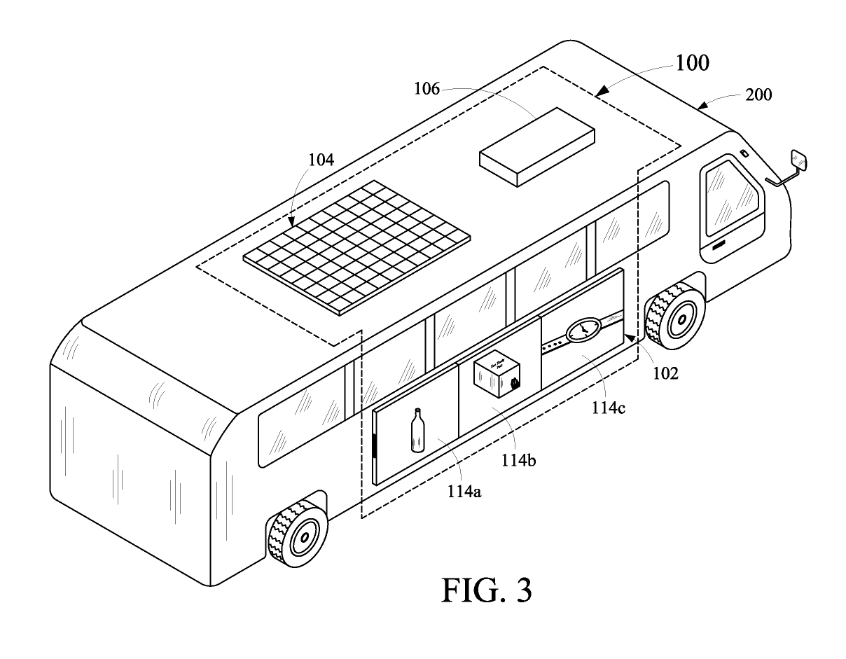

Further, the display module 102 is depicted in FIG. 2 to include a single display screen, i.e. the display screen 112, capable of displaying the advertisement content thereon. However, it will be evident to a person skilled in the art that a display module, such as the display module 102, may include any number of display screens, based on a size of a vehicle and a preference of a user, which is further explained in conjunction with FIG. 3. Further, as shown in FIG. 2, the display module 102 includes the electrical interface 110 configured on the display screen 112 for enabling the display module 102 to receive the advertisement content. Moreover, as explained herein, the display module 102 is configured with the storage module 108 (not shown in FIG. 2) for storing the received advertisement content. Specifically, the storage module 108 may be integrated with the display module 102, for enabling in configuring the system 100 on the vehicle, such the bus 200. In another embodiment, the storage module 108 may be external or removably attached with regard to the display module 102.

The display screen 112 is capable of displaying the advertisement content thereon. In the present embodiment, the display screen 112 is capable of displaying at least one of dynamic advertisement content and static advertisement content. Specifically, the system 100 may be configured to display the dynamic advertisement content, which changes with time, and the static advertisement content, which remains static with time. For example, in case of static advertisement content, a display screen, such as the display screen 112, displays a single visual clip of a product or a service, which remains static with the time in the display screen 112. Further, in case of the dynamic advertisement content, the display screen 112 displays different visual clips of the product or a service, that changes with the time in the display screen 112. For example, as shown in FIG. 2 the display screen 112 displays a visual clip of a car model. In case, the advertisement content is the static advertisement content, the display screen 112 will represent a single visual clip of the car, which remains static with the time in the display screen 112. Alternatively, in case of the dynamic advertisement content, the display screen 112 displays different visual clip of the car, such as a car commercial, that changes with the time in the display screen 112. Additionally, the display screen 112 may be utilized to display different advertisement content related to different products either statically or dynamically.

Referring now to FIG. 3, the system 100 including a display module 102 configured with multiple display screens for displaying advertisements on the bus, in accordance with another exemplary embodiment of the present invention. As explained in conjunction with FIG. 1 and FIG. 2, the display module 102 includes at least one display screen. Accordingly, in one embodiment of the present invention, the display module 102 includes three display screens, such as the display screens 114a, 114b and 114c (hereinafter collectively referred to as display screens 114), for displaying advertisement content. The display screens 114a, 114b and 114c are similar to the display screen 112 explained in conjunction with FIGS. 1 and 2. Further, the display screens 114 may be used for displaying single advertisement content or multiple advertisement content. For example, as shown in FIG. 3, the display screens 114, displays advertisement content representing three products. Specifically, the display screens 114a, 114b, and 114c display advertisement content regarding three different products, such as a beverage bottle, a food container, and a wrist watch, respectively. However, it may be obvious to person skilled in the art that, the display screens 114 may display advertisement content representing a single product, such as the beverage bottle.

Further, the advertisement content representing a single product or multiple products may be dynamic advertisement content or static advertisement content. For example, in case of the static advertisement content, the display screens 114 may display a single visual clip of a single product or multiple products, which remains static with the time in the display screens 114. Further, in case of the dynamic advertisement content, the display screens 114 may display different visual clips of the single product or the multiple products, which changes with the time in the display screens 114.

The system 100 as explained in conjunction with FIGS. 1 through 3 may be subjected to many variations. In one embodiment of the present invention, the system 100 further includes a cover member (not shown) capable of enclosing the display module 102 on occurrence of inclement weather. Specifically, the cover member is capable of enclosing the display screen 112 for protecting from weather elements, such as rain and sun rays. In another embodiment of the present invention, the display screen 112 may include a camera for capturing images of a surrounding of the vehicle, such as the bus 200. The camera of the display screen 112 may act as a security system for recording activities in and around the vehicle. In yet another embodiment of the present invention, the display screen 112 may include fans for directing hot air away from a backside of the display screen 112. Specifically, in order to accommodate the fans, located on the backside of the display screen 112, the vehicle, such as the bus 200, may have vents for accommodating fans therein and to provide a route for the hot air to blow away from the backside of the display screen 112.

An advertisement display system, such as the system 100, enables in displaying advertisement content to a majority of audiences on a repeated and consistent basis. The advertisement content display system is capable of displaying advertisement content representing a single product or a multiple product in at least one of a dynamic manner and a static manner. Further, the advertisement content display system of the present invention possesses inherent environmental benefits and generates environmental awareness amongst people viewing the advertisement content. Specifically, the use of a rechargeable lithium ion battery, such as the rechargeable lithium ion battery 106, and OLED screens enables the advertisement content display system to possess inherent environmental benefits. Moreover, the use of such elements, i.e., the rechargeable lithium ion battery and OLED screens generates environmental awareness amongst people, viewing the advertisement content in the advertisement content display system of the present invention. The display module, such as the display module 102 may also be configured to display advertisement content related to environmental issues and thereby enable generating awareness regarding the environmental issues. Further, the dynamic display of advertisements enables merchants and business establishments to preclude printing costs, such as for printing advertisement content, thereby enabling display of advertisements in a cost effective manner.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present invention.

What is claimed is:

1. An advertisement display system comprising:
a display module for receiving and displaying advertisement content, the display module capable of being mounted on a vehicle; and
an array of solar panels for providing power to the display module for displaying the advertisement content, the array of solar panels capable of being mounted on the vehicle.

2. The advertisement display system of claim 1, further comprising a storage module for storing the received advertisement content.

3. The advertisement display system of claim 1, further comprising a rechargeable lithium ion battery capable of being charged by the array of solar panels for providing power to the display module.

4. The advertisement display system of claim 1, wherein the display module comprises at least one display screen, each display screen of the at least one display screen capable of displaying at least one of a dynamic advertisement content and a static advertisement content.

5. The advertisement display system of claim 4, wherein the each display screen of the at least one display screen is an Organic Light Emitting Diode (OLED) screen.

6. The advertisement display system of claim 4, wherein the each display screen of the at least one display screen is a Liquid Crystal Display (LCD) screen.

7. The advertisement display system of claim 1, wherein the display module is configured with an electrical interface for receiving the advertisement content.

8. The advertisement display system of claim 7, wherein the electrical interface is at least one of a Universal Serial Bus (USB) interface, an wireless communication port, an infrared port, a compact disc (CD) reader, and a Digital Video Device (DVD) reader.

9. The advertisement display system of claim 1, further comprising at least one alternative power source for providing power to the display module.

10. The advertisement display system of claim 9, wherein the at least one alternative power source is a rechargeable battery of the vehicle.

11. The advertisement display system of claim 1, further comprising a cover member capable of enclosing the display module on occurrence of inclement weather.
